(19) United States
(12) Patent Application Publication
(10) Pub. No.: US 2025/0378514 A1
(43) Pub. Date: Dec. 11, 2025

(54) METHODS AND SYSTEMS FOR MUSIC RIGHTS AND ROYALTIES MANAGEMENT- ROP PLATFORM (RAINDROPS ON PETALS PLATFORM) A BLOCKCHAIN-BASED MUSIC RIGHTS AND ROYALTIE MANAGEMENT SYSTEM WITH METADATA TRACKING ON DISTRIBUROR PLATFORMS

(71) Applicant: Bianca Clinton, London (GB)

(72) Inventor: Bianca Clinton, London (GB)

(21) Appl. No.: 18/736,439

(22) Filed: Jun. 6, 2024

(51) Int. Cl. G06Q 50/18; G06F 21/10; G06Q 30/04

(52) U.S. Cl. CPC G06Q 50/184; G06F 21/1015; G06Q 30/04; G06Q 2220/00

(57) ABSTRACT

A blockchain-based system for managing music rights and royalties is disclosed. The system enables artists and contributors to upload music, assign revenue percentages, and track usage via smart contracts on a distributed ledger. Play counts are immutably recorded across distributor platforms. A contributor dashboard provides real-time access to royalty data. The platform incorporates Majority Reports to validate metadata matches and calculate royalties, and Minority Reports to flag discrepancies without payments, thereby ensuring data integrity. A Golden Box smart contract module replicates song rankings and applies predictive classification models to identify features associated with musical success. These mechanisms improve transparency, accuracy, and fraud prevention in royalty distribution.

### FIELD OF THE INVENTION

The present invention relates generally to data processing. More specifically, the present invention is methods and systems for music rights and royalties management with metadata tracking based on blockchain.

### BACKGROUND OF THE INVENTION

The field of data processing is technologically important to several industries, business organizations, and/or individuals. In particular, the use of data processing is prevalent for music rights and royalties management.

Existing techniques for music rights and royalties management are deficient with regard to several aspects. For instance, current technologies do not allow for transparent and automated revenue sharing based on the play count of each song. Furthermore, current technologies do not allow users to streamline their workflows and optimize revenue streams through efficient licensing and content management. Moreover, current technologies do not facilitate secure, decentralized, and transparent tracking of music metadata such as a song title, an artist name, a release date, and ownership information.

Therefore, there is a need for improved methods and systems for music rights and royalties management that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some embodiments, a method for music rights and royalties management with metadata tracking based on blockchain is disclosed. Further, the method may include receiving, using a communication device, at least one media content and at least one media information associated with the at least one media content from at least one user device associated with at least one user. Further, the method may include storing, using a storage device, the at least one media information in a distributed ledger. Further, the method may include receiving, using the communication device, a consumption data associated with the at least one media content from at least one second user device associated with at least one second user. Further, the method may include determining, using a processing device, a media consumption information based on the consumption data. Further, the method may include processing, using the processing device, the media consumption information and the at least one contribution information. Further, the method may include determining, using the processing device, a royalty distribution plan based on the processing. Further, the method may include transmitting, using the communication device, one or more payments based on the royalty distribution plan to one or more artist devices associated with the one or more artists. Further, the method may include storing, using the storage device, the media consumption information, the royalty distribution information, and the one or more payment information in the distributed ledger.

In further embodiments, a system for music rights and royalties management with metadata tracking based on blockchain is disclosed. Further, the system may include a communication device configured for receiving at least one media content and at least one media information associated with the at least one media content from at least one user device associated with at least one user. Further, the communication device may be configured for receiving a consumption data associated with the at least one media content from at least one second user device associated with at least one second user. Further, the communication device may be configured for transmitting one or more payments based on the royalty distribution plan to one or more artist devices associated with the one or more artists. Further, the system may include a processing device configured for determining a media consumption information based on the consumption data. Further, the processing device may be configured for processing the media consumption information and the at least one contribution information. Further, the processing device may be configured for determining a royalty distribution plan based on the processing. Further, the system may include a storage device configured for storing the at least one media information in a distributed ledger. Further, the storage device may be configured for storing the media consumption information, the royalty distribution information, and the one or more payment information in the distributed ledger.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a flow diagram of a method for a smart contract for facilitating music rights and royalties management with metadata tracking based on blockchain, in accordance with some embodiments.

FIG. 3 is a flow diagram of a method for facilitating speech recognition, in accordance with some embodiments.

FIG. 4 is a flow diagram of a method for facilitating metadata extraction using a smart contract, in accordance with some embodiments.

FIG. 5 is a flow diagram of a method for facilitating obtaining a total number of times a song is played, in accordance with some embodiments.

FIG. 6 is a flow diagram of a method for facilitating calculating royalties, in accordance with some embodiments.

FIG. 7 is a flow diagram of a method for facilitating generating a majority report, in accordance with some embodiments.

FIG. 8 is a flow diagram of a method for facilitating generating a minority report, in accordance with some embodiments.

FIG. 9 is a flow diagram of a method for facilitating replicating the ranking of the most played songs and finding common features, in accordance with some embodiments.

FIG. 10 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems for music rights and royalties management with metadata tracking based on blockchain, embodiments of the present disclosure are not limited to use only in this context.

### Overview:

The present disclosure describes methods and systems for music rights and royalties management with metadata tracking based on blockchain. Further, the-based on distributor platforms. Further, the disclosed system may be associated with a software platform (such as a software application and website). Further, ROP platform (“raindrops on petals platform”), an exemplary embodiment of the disclosed software platform, may facilitate music rights and royalties management system with metadata tracking on distributor platforms.

### 1.A Introduction

1. What Raindrops on Petals invention accomplishes
The Software acts as a Music Platform where Music Artists can upload their songs along with the revenue distribution between himself/herself and other contributors. Listeners can listen to music. Based on the agreed revenue distribution, for every song play count the revenue is distributed between its contributors and the artist.
Raindrops on Petals offers software solutions for record labels and music publishers to manage their content, copyrights, and licensing agreements. Our customizable platform enables users to streamline their workflows and optimize revenue streams through efficient licensing and content management. Raindrops on Petals aims to provide a comprehensive solution for managing and monetizing music content, ensuring that record labels and publishers can effectively handle their intellectual property rights and licensing processes.
   Raindrops on Petals Web Application Works as a Single Unit. It Utilizes Several External Components to Enhance its Functionality:
MongoDB Cloud Database (Atlas): This component provides efficient and secure data storage for the platform, ensuring scalability and reliability.
Cloud Hosting: Raindrops on Petals leverages cloud hosting, which enables the application to be hosted on remote servers, ensuring high availability and optimal performance.
Blockchain (Smart Contract)—Polygon: Raindrops on Petals integrates blockchain technology, specifically the Polygon blockchain, through the use of smart contracts. This integration ensures secure and transparent tracking of music metadata, play counts, and revenue distribution.
Web Application: Raindrops on Petals is a web-based application accessible through a web browser, allowing users to access its features and functionalities seamlessly.
Frontend—React JS, Tailwind CSS: The frontend of Raindrops on Petals is built using React JS, a JavaScript library for building user interfaces. Tailwind CSS is used for styling, providing a customizable and responsive design.
Backend—Express JS: The backend of Raindrops on Petals is developed using Express JS, a web application framework for Node
   Raindrops on Petals Distinguishes Itself with a:
1. Revenue Distribution Platform: Raindrops on Petals offers a software platform where music artists can upload their songs along with the agreed revenue distribution between themselves and other contributors. This feature allows for transparent and automated revenue sharing based on the play count of each song. This innovative approach ensures that all contributors and the artist receive their fair share of revenue generated by the music.
2. Streamlined Workflow and Content Management: Raindrops on Petals provides a customizable platform for record labels and music publishers to manage their content, copyrights, and licensing agreements. This feature enables users to streamline their workflows and optimize their revenue streams through efficient licensing and content management. By offering a comprehensive solution, Raindrops on Petals helps organizations effectively handle their intellectual property rights and licensing processes.
3. Blockchain-based Metadata Tracing: Raindrops on Petals utilizes blockchain technology for metadata tracing in the music industry. This innovative approach allows for secure, decentralized, and transparent tracking of music metadata such as a song title, an artist name, a release date, and ownership information. By recording this information on a blockchain network, Raindrops on Petals ensures accurate tracking and real-time payment of royalties to all parties involved in the creation and distribution of music. This eliminates the need for intermediaries, reduces royalty fraud, and promotes fair distribution of royalties.
4. Improved Royalty Calculation and Payment Process: Raindrops on Petals addresses the challenges associated with royalty calculation and payment in the music industry. The traditional manual process, involving multiple intermediaries and complex reporting, can be slow and prone to errors. Raindrops on Petals' software streamlines the royalty payment process, enabling faster and more accurate payments to rights holders. By automating calculations and leveraging blockchain technology, Raindrops on Petals reduces payment delays and disputes, improving the overall efficiency and transparency of royalty distribution. In summary, Raindrops on Petals stands out distinctly by offering an innovative revenue distribution platform, a customizable workflow and content management solution, blockchain-based metadata tracing, and an improved royalty calculation and payment process. These unique features contribute to Raindrops on Petals' ability to address key challenges in the music industry and provide efficient and transparent solutions for artists, rights holders, record labels, and music publishers.

Further, the disclosed software provides solutions for record labels and music publishers to manage their content, copyrights, and licensing agreements through a customizable platform that allows users to streamline their workflows and optimize their revenue streams through licensing and content management.

### 1.B. The Raindrops on Petals Invention Accomplishes Several Key Objectives:

1. Music Platform for Artists: The software acts as a music platform where music artists can upload their songs. This allows artists to showcase and distribute their music to a wider audience. Listeners can access and enjoy the music through the platform.

2. Revenue Distribution: Raindrops on Petals provides a mechanism for revenue distribution between music artists and other contributors. Artists can specify the revenue distribution agreements for their songs. Based on the agreed-upon revenue splits, for every play count of a song, the revenue is automatically distributed between the artist and the contributors. This ensures fair compensation and transparent revenue sharing among the stakeholders.

3. Content Management for Record Labels and Publishers: Raindrops on Petals offers software solutions tailored for record labels and music publishers. The platform provides tools to manage content, copyrights, and licensing agreements. Users can streamline their workflows and optimize revenue streams through efficient licensing and content management. This comprehensive solution enables record labels and publishers to effectively handle their intellectual property rights and licensing processes.

4. Blockchain-based Metadata Tracing: Raindrops on Petals utilizes blockchain technology to address issues related to royalty distribution and copyright ownership. By leveraging blockchain, the software enables secure, decentralized, and transparent tracking of music metadata such as a song title, an artist name, a release date, and ownership information. This blockchain-based metadata tracing ensures accurate tracking of music usage and enables real-time payment of royalties to relevant parties whenever a song is played, streamed, or purchased. This eliminates the need for intermediaries, reduces instances of royalty fraud, and ensures a fair distribution of royalties to all stakeholders involved in the creation and distribution of music.

Overall, Raindrops on Petals aims to provide a comprehensive solution for managing and monetizing music content. It offers features like revenue distribution, content management for record labels and publishers, and blockchain-based metadata tracing to improve the efficiency, transparency, and fairness of the music industry's royalty distribution and licensing processes.

The accompanying drawings, which are incorporated in and constitute a part of this disclosure, illustrate various embodiments of the present disclosure.

Metadata tracing with blockchain technology in the music industry can help resolve issues of royalty distribution and copyright ownership. Blockchain enables secure, decentralized, and transparent tracking of music metadata such as song title, artist name, release date, and ownership information. With this information recorded on a blockchain network, every time a song is played, streamed, or purchased, the relevant parties can be accurately tracked and paid their due royalties in real-time. This can help eliminate the need for intermediaries, reduce instances of royalty fraud, and ensure a fair distribution of royalties to all parties involved in the creation and distribution of music. Additionally, blockchain-based metadata tracing can also provide a more secure and tamper-proof means of tracking music rights and royalties, which can further protect the rights of artists and other stakeholders in the music industry. Royalties in the music industry are typically paid out to artists, songwriters, and other rights holders for the use of their music. Currently, the process of paying royalties in the music industry is largely manual and can be complex, involving multiple intermediaries, different royalty rates, and a variety of reporting and payment processes.

Royalties are generally paid by music streaming services, radio stations, and other music-use licensees to music industry organizations such as performance rights organizations (PROs) and mechanical rights organizations. These organizations are responsible for collecting and distributing royalties to the rights holders. In the traditional model, royalty payments are calculated based on the number of times a song is streamed, played, or sold, and the royalty rate negotiated between the rights holder and the music industry organization. The payment process can be slow, with royalties sometimes taking several months or more to reach the rights holder. Additionally, there is a high risk of errors and inaccuracies in the royalty calculation and payment process, as well as disputes over the proper distribution of royalties. The royalty amounts paid to each party depends on the amounts of rights that they own, and the category. Rights are split at a high level into two categories:
Composition Rights—the song lyrics, melody, and other elements of a piece of music. The rights to which are automatically given at the point of composition (e.g. when it's written down as either words or sheet music). Royalties will be paid to these rights owners based on the use of the composition (e.g. if someone uses the melody for another piece of music).
Master Rights—when the song is recorded to audio. This is then partially owned by the artist and usually by the Record Label to which they are signed. Royalties will be paid to these rights owners when the piece of music is played (e.g. on the radio).

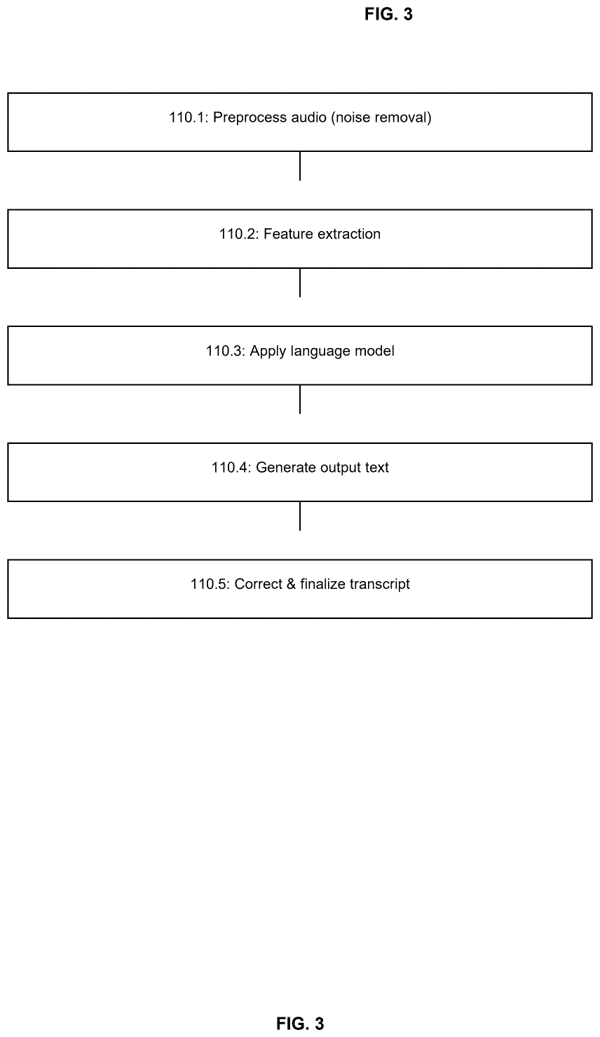

Further, the disclosed system tracks metadata collected from a song or any audio. The picture above shows the high-level view of the whole system. The system consists of 5 smart contracts in total. The First Smart contract deals with speech-to-text conversion of the audio which is speech recognition (110). The second smart contract is metadata extraction, this smart contract is responsible for the extraction of the metadata from the song (120). A third smart contract is a counting model, responsible for stating the total number of times the song is played (130). A fourth smart contract is responsible for the distribution of the royalties (140). We have majority and minority report smart contract as well with the counting model. A majority report is displayed in case of successful match (130.a) otherwise minority report is generated (130.b). Golden box smart contract provides the highest rated songs and similarity between them (150). In the end, we have a datastore which contains all the data reserves required for the system to run efficiently. Let's look at each smart contract in detail and separately in the next section. The high level view of the system just gives the overall view of the system and shows the functionality performed by each smart contract to provide a clear understanding to the users/developers. FIG. 3 is a flow diagram of a method for facilitating speech recognition, in accordance with some embodiments.

### 1.C. Process Flow

### 1. Speech Recognition Smart Contract

If a person is listening to a song or music on a distributor platform our extension tries to recognize the audio playing. First, the audio is preprocessed, this removes the noise from the audio signal (110.1). Making the sound more clear and easier for the system to recognize. The next step is feature extraction different machine learning methods are applied to the input in order to get features (110.2, 110.3). These features play an important role in the generation of the output text. A language model is a grammatical information and semantic rules of the language. A language model is important as it recognizes the language and generates the output text based on it (110.4). The correction is also made at this step. Deep learning models like convolutional neural networks (CNNs), recurrent neural networks (RNNs), and Transformer networks have shown great results in the speech recognition field (110.5).

The authors and the contributor's login using their own digital currency/crypto wallet address or email/pass. But before uploading the song the author must connect wallet address. Similarly, the contributor must connect their wallet address to see their revenue distribution. The listener need not connect their wallet address.

The author creates an album, uploads songs to it along with the revenue distribution percentage. The metadata and the revenue distribution are stored in smart contract and other data are stored in MongoDB. Once that is done, the listeners can login and listen to music.

The smart contract keeps track of the play count of each song and records it. This data can later be used to distribute royalty among the artists and the contributors.

The contributors can login and see the songs they have contributed and the royalty % distributed for them.

Raindrops on Petals differentiates itself through its login process, where authors and contributors can access the platform using their digital currency/crypto wallet address or email/pass. The connection of the wallet address ensures secure authentication and verification. The author creates an album and uploads songs, specifying the revenue distribution percentage. The metadata and revenue distribution information may be stored in a smart contract, while other data is stored in MongoDB.

Listeners can log in and enjoy the music available on the platform. The smart contract keeps track of the play count for each song, which is later utilized to distribute royalties among artists and contributors.

The ability for contributors to log in and view the songs they have contributed to, along with the royalty percentages distributed to them, demonstrates Raindrops on Petals' commitment to transparency and accountability in revenue sharing.

### 2.B Raindrops on Petals Presents Several Innovative Distinctions:

1. Integration of Blockchain Technology: Raindrops on Petals incorporates blockchain technology by storing metadata and revenue distribution information in a smart contract. This enables secure and transparent tracking of music data, including play counts, and ensures accurate royalty distribution. The utilization of blockchain can enhance trust, eliminate intermediaries, and reduce instances of fraud in royalty distribution, setting it apart from the other companies.
2. Digital currency/cryptocurrency Wallet Integration: The Raindrops on Petals platform allows authors and contributors to connect their digital currency/crypto wallet addresses. This integration enables seamless revenue distribution to contributors based on the agreed-upon percentage. By leveraging digital currency/cryptocurrency wallets, Raindrops on Petals offers a novel approach to handling revenue distribution, differentiating itself from the other companies.
3. MongoDB Integration: Raindrops on Petals stores certain data in MongoDB, a popular NoSQL database. By utilizing this database technology, the platform can efficiently manage and retrieve non-sensitive information, enhancing scalability and performance. This integration showcases an innovative approach to data storage and management compared to the other companies.
4. User-Friendly Interface: Raindrops on Petals provides a user-friendly interface that allows authors to create albums, upload songs, and define revenue distribution percentages. Contributors can easily log in to view the songs they have contributed to and the corresponding royalty percentages. This emphasis on user experience and simplicity sets Raindrops on Petals apart.

In summary, Raindrops on Petals distinguishes itself through its integration of blockchain technology, digital currency/cryptocurrency wallet connectivity, utilization of MongoDB for data storage, and a user-friendly interface for seamless music management and royalty distribution. These innovative features contribute to a unique value proposition within the music industry.

Essentially, the authors and the contributors log in using their own digital currency/crypto wallet address or email/pass. But before uploading the song the author must connect the wallet address. Similarly, the contributor must connect their wallet address to see their revenue distribution. The listener need not connect their wallet address. The author creates an album and uploads songs to it along with the revenue distribution percentage. The metadata and the revenue distribution are stored in smart contracts and other data are stored in MongoDB. Once that is done, the listeners can login and listen to music. The smart contract keeps track of the play count of each song and records it. This data can later be used to distribute royalty among the artists and the contributors. The contributors can login and see the songs they have contributed and the royalty % distributed for them.

### 2.C. Metadata Extraction Smart Contract

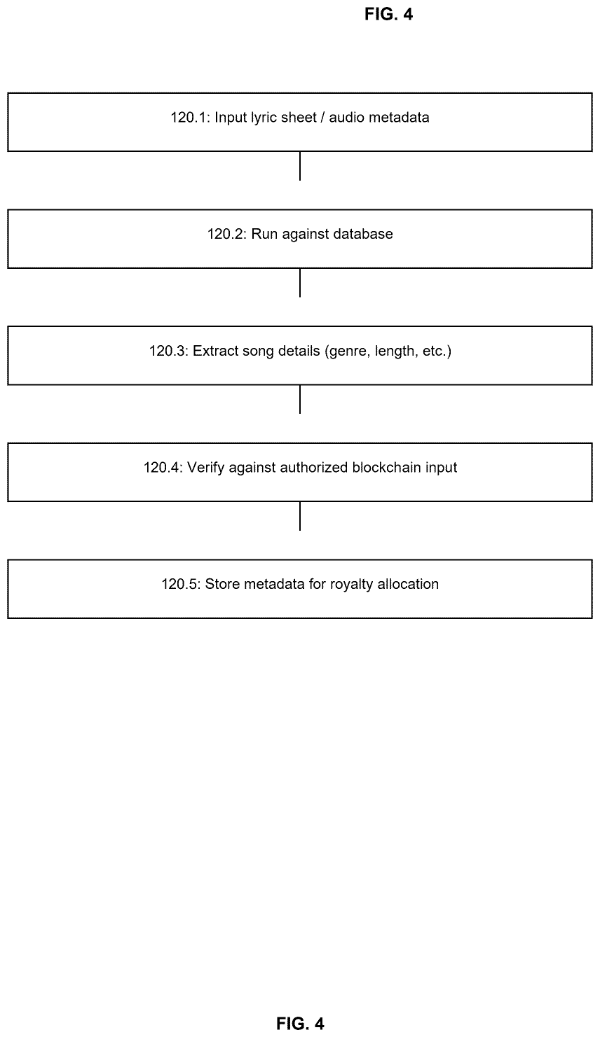

FIG. 4 is a flow diagram of a method for facilitating metadata extraction using a smart contract, in accordance with some embodiments. Accordingly, metadata is a valuable source that helps in organization and search. With metadata similar documents, images, videos can be easily accessed. Next step is to extract metadata from the output obtained in the previous step. There are different ways in which we can obtain the metadata of the song or music. First is that the lyric sheet we obtained is run through a database of songs if a match is found the music with all its details is extracted and displayed. Second, what we can do is extract the metadata from the audio but this metadata is limited to the genre, length of song, and category of a song. Different models are there to do classification of sound i.e., beach search, data extraction, and augmentation (120.3,120.4). In the end of this smart contract, we obtain metadata of the music and song playing on the distribution platform (120.6). Another way to get metadata from the songs is by allowing companies to make accounts on the software and enter their own correct details and collect royalties. This will fast-track the system. Anyone who has access to the blockchain can correct, enter and add details. Blockchain will allow only authorized users to perform certain functions.

### 2.D. Counting Model Smart Contract

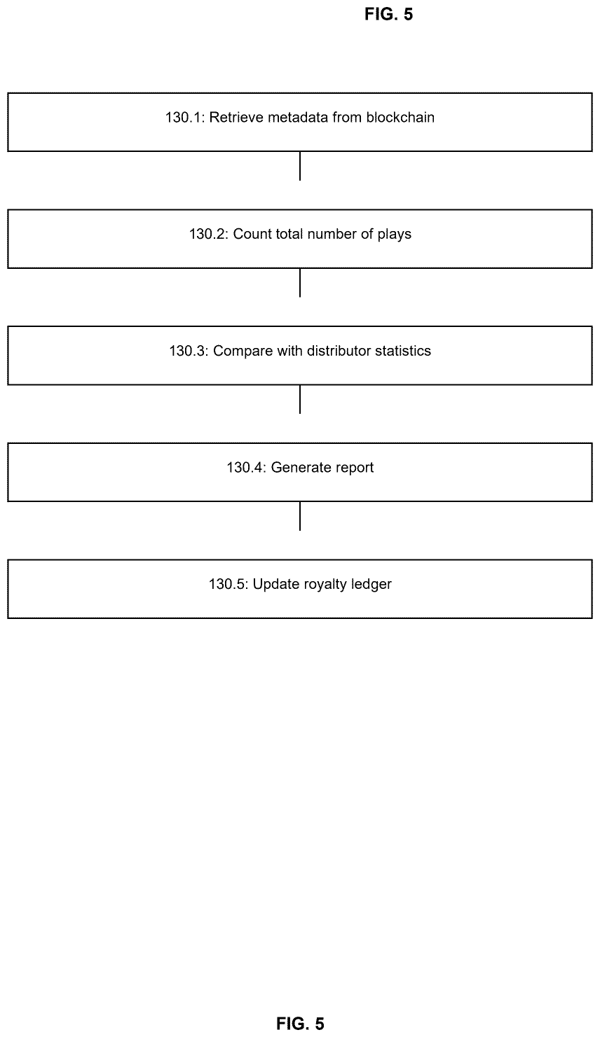

FIG. 5 is a flow diagram of a method for facilitating obtaining a total number of times a song is played, in accordance with some embodiments. This smart contract is responsible for obtaining the total number of times the song is played. The metadata obtained from the previous step is used to count the number of times the song is played (130.1). These readings can be collected from the datastore or an online search is conducted with the help of metadata which collects the average number of times this song has been played on other famous distribution platforms or an authentic official website of song (130.2). The statistics of the song played count shown on the website is compared to our reading and a report is generated. As all the data is stored on the blockchain and every transaction and information is transparent, the number of times a song is played will be updated on the system and respective company will be paid royalties.

Further, the disclosed system may function as a listening portal for listeners. Further, the disclosed system may function as a music management portal for artists. Further, the disclosed system may provide a revenue % tracking dashboard for contributors. Further, the disclosed system may be based on a smart contract that tracks the song count.

Raindrops on Petals presents several innovative distinctions in its components:

a. Listening Portal for Listeners: Raindrops on Petals offers a dedicated listening portal for listeners, allowing them to access and enjoy the music uploaded by artists. This portal provides a user-friendly interface for seamless music playback and enhances the overall listening experience. While other platforms may also have listening portals, Raindrops on Petals may differentiate itself through its user interface, features, and integration with other components.

b. Music Management Portal for Artists: Raindrops on Petals provides a music management portal specifically designed for artists. This portal enables artists to create albums, upload their songs, and define revenue distribution percentages. The portal likely offers additional features such as metadata management, analytics, and content customization options. The emphasis on providing a comprehensive and artist-focused music management solution sets Raindrops on Petals apart.

c. Revenue % Tracking Dashboard for Contributors: Raindrops on Petals includes a revenue percentage tracking dashboard for contributors. This dashboard allows contributors to log in and monitor the revenue distribution for the songs they have contributed to. By providing contributors with transparency and real-time insights into their earnings, Raindrops on Petals offers a unique feature that promotes trust and engagement among contributors.

d. Smart Contract that tracks the song count: Raindrops on Petals utilizes a smart contract to track the count of plays for each song. This integration of smart contracts enables accurate tracking of song plays, which is crucial for royalty distribution. The use of smart contracts for this purpose enhances transparency and ensures that artists and contributors receive fair compensation based on the actual usage of their music. This feature sets Raindrops on Petals apart from platforms that may employ traditional manual tracking methods.

In summary, Raindrops on Petals distinguishes itself by having a dedicated listening portal, artist-focused music management portal, revenue tracking dashboard for contributors, and the use of smart contracts for accurate song play count tracking. These distinctive components contribute to Raindrops on Petals' innovative approach in the music industry.

### 3.B. Royalties Distribution Smart Contract

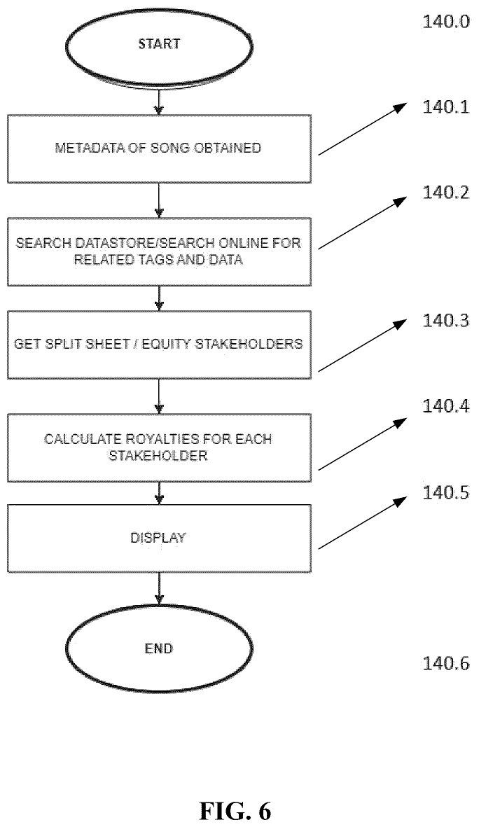

FIG. 6 is a flow diagram of a method for facilitating calculating royalties, in accordance with some embodiments. When we have found the total number of count it is time to calculate royalties for the stakeholders. Our platform also works as a royalties' distributor information so that we may know how much each stakeholder is making money. The metadata fetches the split sheet or equity stakeholders of the song as well (140.2) The split sheet holds the data about the equity stakeholders and how much percentage of earning each stakeholder receives (140.3). We have derived a formula to calculate the royalties for each stakeholder. The formula takes the percentage of each equity holder and multiplies with the song count retrieved from the counting model (140.4). This determines the royalties of each stakeholder. All the data fetching depends on metadata tracing. The result is displayed at the end (140.5).

### 3.C. Datastore

The datastore in our system could be a local or an online repository. In this datastore, the music with its details is stored. The music details could be the artists' name, song writer, lyrics, a release date, music band, license, etc. These details could be already present in the datastore or our system can search online to find the data of the song being recognized and add it to datastore. This reduces the time required to conduct a search every time online the data of the music can be accessed in no time from the datastore. 4A.

The whole software works as a single unit it's a web application.

The Software has external components like the,
+MongoDB Cloud Database (Atlas)
+Cloud Hosting
+Blockchain (Smart Contract)—Polygon
+Web Application
   +Frontend—React JS, Tailwind CSS
   +Backend—Express JS

### Detailed Explanation:

### Parties:

There are 3 parties involved—Listeners, Authors, and Contributors

### Components:

Signup component
All the 3 parties need to sign up to use the application
Everyone has options to sign up using either mail or wallet address. If signing up via mail, all the passwords are hashed and stored.
In the wallet signup process, when signing up, the user's MetaMask will send out a prompt and ask the user to sign a random string, unique to that user. This is to get the signature of that particular address. This signature is hashed and stored in the MongoDB.

### Login Component

All the 3 parties can login using email/pass or wallet address
When a user logs in with the wallet address, the user is asked to sign the unique string and then the backend will cross reference the hashes. If the same, a user can log in, else fails.

### Author Components

Author have option to create an album
And then upload the song to the respective album.
While uploading the author will be providing a list of royalty share percentages for themselves and for other contributors. The data relating to royalty will be stored in the smart contract mapped with the author ID. The rest of the metadata is stored in MongoDB.
Author has options to check their album, songs, play counts, and royalty generated.
The song data is fetched from MongoDB and the royalty and song count data is fetched from Smart Contract.

### Listener Components

Listener have the option to listen to songs
The song data is fetched from MongoDB and the royalty and song count data is fetched from Smart Contract.
Listener can like/dislike songs
When a listener listens to a song a request is sent to MongoDB to retrieve the song and another request to the blockchain to update the song count in the smart contract.

### Contributor Component

Contributors can login and see their dashboard. This will fetch the data related to Royalty from the Smart Contract and metadata from MongoDB and display it on the dashboard.

In addition to the free and paid user model, it is important to emphasize that Raindrops on Petals will generate revenue through a software license fee charged to music companies for each client they have on our platform. This fee will be a significant source of revenue for Raindrops on Petals.

Furthermore, an organization and individual associated with the disclosed system may also receive a 10% share of the additional revenue generated by music companies using the disclosed software. This means that any revenue generated by music companies through the utilization of Raindrops on Petals platform, beyond their existing revenue streams, will be subject to a 10% share going to Raindrops on Petals. Further, Raindrops on Petals software has the ability to identify unclaimed revenue for music companies. Through our advanced algorithms and data analysis, we can identify revenue that music companies may have overlooked or missed in their existing revenue streams. This discovery of unclaimed revenue is a distinct feature of our software, providing added value to music companies and further solidifying our position in the market. Implementing the pricing feature, along with the differentiation between free and paid users, will allow us to provide a comprehensive experience for our users while also aligning with our revenue generation strategy. By capturing a software license fee per client from music companies and securing a 10% share of additional revenue, Raindrops on Petals may position itself as a revenue-generating solution for the music industry.

### Raindrops on Petals' Process:

1. Parties: There are three main parties: Listeners, Authors, and Contributors. This differentiation shows that Raindrops on Petals caters to the needs of various stakeholders in the music industry, ensuring a comprehensive platform.
2. Signup Component: The signup process allows all parties to register and use the application. The option to sign up using email or wallet address provides flexibility to the users. The integration with MetaMask and the storage of hashed signatures in the MongoDB database adds an extra layer of security to the platform.
3. Login Component: Raindrops on Petals allows all parties to login using either email/pass or wallet address. The verification process for wallet address login, which involves signing a unique string and cross-referencing the hashes, enhances security and ensures secure access to user accounts.
4. Author Components: Authors have the option to create albums and upload songs to those albums. The ability to specify royalty share percentages for themselves and other contributors showcases Raindrops on Petals' focus on fair revenue distribution. Storing royalty data in the smart contract mapped with the author ID and other metadata in MongoDB ensures efficient management of the platform's content.
5. Listener Components: Listeners can access and listen to songs on Raindrops on Petals. The integration with MongoDB and the smart contract allows for retrieving song data, royalty information, and play counts. The ability to like/dislike songs adds interactivity and engagement for listeners. Additionally, the request sent to update the song count in the smart contract reflects Raindrops on Petals' commitment to accurate tracking of play counts for royalty distribution.
6. Contributor Component: Contributors have their own dashboard where they can access data related to their royalties. By fetching royalty information from the smart contract and metadata from MongoDB, Raindrops on Petals ensures contributors can easily monitor and track their earnings.

Overall, the detailed explanation highlights Raindrops on Petals' comprehensive approach, emphasizing secure authentication, fair revenue distribution, accurate tracking of play counts, and personalized dashboards for contributors. These aspects contribute to Raindrops on Petals' distinctiveness the pricing model for both free and paid users, particularly for music companies, can be explained as follows:

### Free Users:

Free users are typically listeners who can access the Raindrops on Petals platform without any payment.

Free users have limited functionalities and may have restrictions on certain features. They can listen to songs uploaded by music artists and enjoy the platform's basic features. Free users do not have the ability to upload their own songs or access advanced features like creating albums or contributing to revenue distribution.

The purpose of offering free access is to attract a larger user base and provide a taste of the platform's offerings.

### Paid Users (Music Companies):

Music companies, as paid users, have access to advanced features and functionalities within Raindrops on Petals.

These companies pay a software license fee per client to Raindrops on Petals, enabling them to utilize the platform's services and tools for their music-related activities.

In addition to the software license fee, Raindrops on Petals also receives 10% of the additional revenue generated by the music companies through the platform.

The additional revenue refers to the earnings generated by the music companies from the utilization of Raindrops on Petals, such as increased song plays, collaborations, or other monetization opportunities facilitated by the platform.

This revenue-sharing model ensures that Raindrops on Petals benefits from the success and growth of the music companies utilizing the platform.

It incentivizes Raindrops on Petals to provide robust services and tools to drive revenue generation for music companies, leading to a mutually beneficial relationship.

By offering both free and paid pricing options, Raindrops on Petals caters to a wider user base, allowing free users to experience the platform while providing value-added services and revenue opportunities to music companies through the paid model. This approach enables Raindrops on Petals to attract and retain users while fostering partnerships with music companies for long-term sustainability and growth.

### 4.B. The Raindrops on Petals Invention is Distinctively Innovative in the Following Ways:

1. Integration of External Components: Raindrops on Petals integrates various external components to enhance its functionality and performance. The incorporation of MongoDB Cloud Database (Atlas) provides a scalable and efficient data storage solution, while cloud hosting ensures the software's availability and reliability. The utilization of the Polygon blockchain (Smart Contract) introduces secure and transparent tracking of music metadata and royalty distribution. These external component integrations contribute to the overall innovation and effectiveness of Raindrops on Petals.
2. Web Application Approach: Raindrops on Petals is developed as a web application, offering accessibility and convenience to its users. By providing a web-based platform, Raindrops on Petals ensures that users can access the software from various devices without the need for specific installations or dependencies. This approach distinguishes Raindrops on Petals from other platforms that may rely on different technologies or have limitations in terms of device compatibility.
3. Frontend and Backend Technologies: Raindrops on Petals utilizes React JS for the frontend and Express JS for the backend development. React JS is a popular and efficient JavaScript library for building user interfaces, while Express JS is a widely used framework for creating web applications and APIs. The combination of these technologies enables Raindrops on Petals to deliver a responsive and interactive user experience while maintaining robust backend functionality.
4. Tailwind CSS for Styling: Raindrops on Petals employs Tailwind CSS for styling its web application. Tailwind CSS is a utility-first CSS framework that provides a flexible and streamlined approach to designing user interfaces. By utilizing Tailwind CSS, Raindrops on Petals can create visually appealing and customizable interfaces with ease, setting it apart from other platforms that may use different styling frameworks or approaches.

In summary, Raindrops on Petals distinguishes itself through its integration of external components such as MongoDB Cloud Database, cloud hosting, and the Polygon blockchain. The web application approach, along with the use of React JS, Express JS, and Tailwind CSS, further contributes to its innovative nature. These distinctive features collectively enhance the functionality, scalability, accessibility, and user experience of Raindrops on Petals.

### 4.C. Critical Points of the Components

The blockchain-based music rights and royalties' management system are:

Critical point: 1. Requirements gathering and analysis: Identifying the key stakeholders and their requirements, such as music publishers, artists, labels, streaming platforms, and performance rights organizations.

Critical point 2: Blockchain selection and setup: Selecting a suitable blockchain platform and setting up the infrastructure for the system, including nodes, consensus mechanisms, and smart contract development tools.

Critical point: 3: Smart contract development: Developing smart contracts to manage the rights and royalties information, such as tracking the ownership of copyrights, calculating royalties, and distributing payments to stakeholders.

Critical point 4: Music metadata management: Integrating the system with existing music metadata databases and developing tools to manage the metadata, such as track and album information, artist credits, and rights ownership data.

Critical point 5: User interface development: Developing a user-friendly interface for stakeholders to interact with the system, including dashboards for monitoring royalties, transaction history, and payments.

Critical point 6: Integration with existing systems: Integrating the blockchain-based system with existing music industry systems, such as music streaming platforms, performance rights organizations, and payment processors.

Critical point 7: Testing and deployment: Testing the system thoroughly to ensure that it meets the requirements, and deploying it to the production environment.

Critical point 8: Monitoring and maintenance: Monitoring the system's performance and making necessary adjustments to ensure its smooth operation and security.

### 5. Majority Report

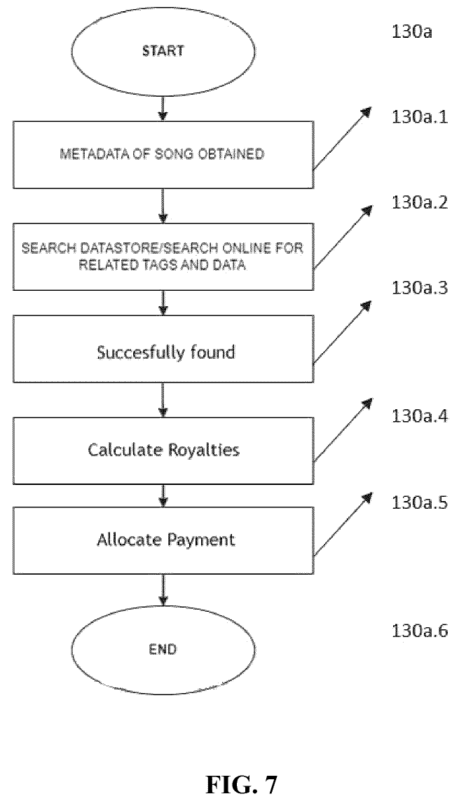

FIG. 7 is a flow diagram of a method for facilitating generating a majority report, in accordance with some embodiments. Accordingly, the majority report is produced when the successful metadata is found. It should be able to run 2 million transactions per second. If the data is found and is a match the royalties is calculated (130a.3,130a.4). A monthly report of songs played is generated. Funds are allocated (130a.5).

### 6. Minority Report

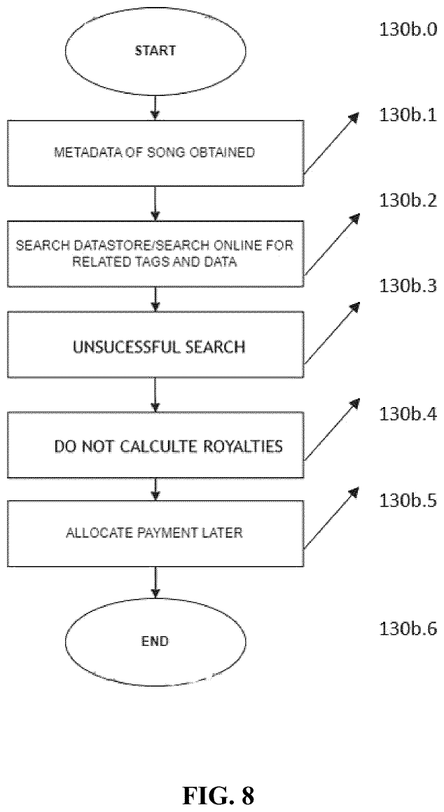

FIG. 8 is a flow diagram of a method for facilitating generating a minority report, in accordance with some embodiments. A minority report is produced if no data is found or is incorrect. The system is efficient up to 98% but an error of 2% is expected. The 2% error is handled by this smart contract. No royalties are calculated and no action is taken in case of incorrect match (130b.4,130b.5).

### 7. Golden Box Smart Contract

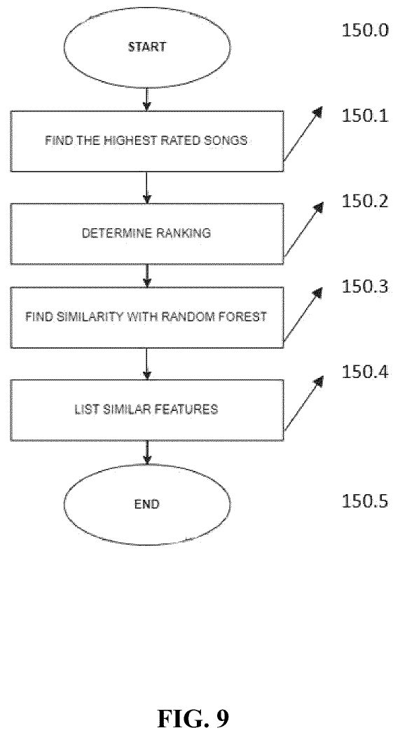

FIG. 9 is a flow diagram of a method for facilitating replicating the ranking of the most played songs and finding common features, in accordance with some embodiments. A golden box smart contract is also present in the disclosed system which is responsible for replicating the ranking of the most played songs and finding common features among them (150.1,150.2). Different music classification models are present which determine the features of the song. Methods like a nearest neighbor and random forest can be used to predict the similarity between the most liked songs (150.3,150.4). The features that make a song likable consist of danceability, instrumentals, energy, loudness, artists, liveness, lyrics, length, acoustics, etc. The perfect ratio of these all makes a song hit. The above-mentioned methods view these features' ratio in every song and predict its outcome.

When a user clicks on a song on any platform like Spotify, Apple Music, or Amazon Music, their phone requests the song from the DSP's server and the content delivery network delivers it to their phone. When a user's device makes the request, another request is concurrently sent to the blockchain. Each time a request comes in, all three nodes detect whether a consumer is a valid consumer and whether a play has met all the play count conditions, and once a play's validity is agreed upon by all three parties, they digital sign/crypto sign a receipt. Therefore, for every single unique play, there's a receipt of the transaction with everyone's digital sign/crypto signature. To run this system on another website or platform we have to add permissions. Which further is granted by the platform or the user in order for us to access the platform data and display information on our extension. Our system does not disclose the identity of the user. The user's name is displayed in a long string which is the public address of the user. No user data is extracted or saved in order to promote marketing or for personal use.

Further, the Raindrops on Petals leverages the concepts of their (5) majority report, (6) minority report, and (7) golden box smart contract in creating hit-making songs within the Raindrops on Petals web application, incorporated into the following functionalities:

### Majority Report:

The majority report is generated when successful metadata is found, indicating a match. To implement this in Raindrops on Petals, a user may:
Use the MongoDB Cloud Database to store and retrieve metadata, including lyrics and song notes.

Implement a high-performance search algorithm that can handle a large volume of transactions per second, aiming for the targeted 2 million transactions per second.

When a successful match is found, calculate the royalties based on predetermined rules (as defined by 130a.3 and 130a.4).

Generate a monthly report of the songs played, providing insights into their popularity and usage.

Allocate funds, such as royalties or revenue shares, based on the calculated amounts (as specified by 130a.5).

### Minority Report:

The minority report comes into play when no data is found or when the data is incorrect. To handle this in Raindrops on Petals, consider:

Accounting for an expected error rate of 2% in the system's efficiency (as mentioned in 130b.4 and 130b.5).

Implementing error handling mechanisms to identify cases where no match or incorrect match occurs.

In these situations, refrain from calculating royalties or taking any actions based on the incorrect match, as specified.

### Golden Box Smart Contract:

The golden box smart contract is responsible for replicating the ranking of the most played songs and identifying common features among them. To utilize this concept within Raindrops on Petals:

Implement the golden box smart contract on the Polygon blockchain, integrating it into the Raindrops on Petals system.

Utilize different music classification models within the smart contract to determine the features of songs, such as danceability, instrumentals, energy, loudness, artists, liveness, lyrics, length, acoustics, and other relevant factors.

Employ methods like nearest neighbor and random forest within the smart contract to predict the similarity between the most liked songs, based on the extracted features (150.3 and 150.4).

Use the determined features and their ratios to assess the potential hit-making qualities of songs, taking into account the preferences of the target audience.

Apply the findings from the golden box smart contract to guide decision-making processes related to promoting certain songs, recommending similar tracks, or providing insights to artists and contributors on what elements contribute to a song's success.

By incorporating these elements into the Raindrops on Petals web application, you can enhance its ability to identify hit-making songs based on popular tracked metadata, lyrics, and song notes.

### The Described Features are Unique Mainly Because:

1. Majority Report: While all platforms may have some form of reporting and royalty calculation, Raindrops on Petals stands out by emphasizing high-performance transaction processing with a target of 2 million transactions per second. This scalability and efficiency enable real-time tracking and accurate calculation of royalties, ensuring that artists and contributors are fairly compensated.
2. Minority Report: Raindrops on Petals acknowledges the possibility of errors or incorrect data and has implemented a specific smart contract to handle the minority report scenario. By accounting for a 2% error rate and establishing protocols to address incorrect matches, Raindrops on Petals demonstrates its commitment to maintaining data integrity and ensuring accurate distribution of royalties.
3. Golden Box Smart Contract: The presence of the golden box smart contract in Raindrops on Petals sets it apart from other platforms. This contract replicates the ranking of the most played songs and employs advanced music classification models to identify common features among them. By leveraging methods like a nearest neighbor and random forest, Raindrops on Petals can predict the likelihood of a song becoming a hit based on a comprehensive set of features. This innovative approach empowers artists, contributors, and music companies with valuable insights into the elements that contribute to the success of a song.

Overall, Raindrops on Petals distinguishes itself by combining high-performance transaction processing, error handling mechanisms, and the utilization of a golden box smart contract for advanced music analysis. These features provide a unique and comprehensive solution for music artists, contributors, and music companies, ensuring accurate royalties, data integrity, and valuable predictive analytics for hit-making potential through:

### Identifying Popular Songs:

While it's true that the songs are received directly from the authors, it is still valuable to identify popular songs within the platform.

By analyzing song play counts, we can determine which songs are gaining traction and becoming popular among the listeners.

This information is crucial for understanding user preferences, identifying trends, and potentially promoting those songs to a wider audience.

### Majority and Minority Reports:

The majority and minority reports are tools that help us handle data discrepancies and ensure accurate royalty calculations.

Although we receive songs directly from authors, errors can still occur in the tracking of song play counts.

The majority report identifies successful metadata matches, allowing us to calculate accurate royalties for the contributors involved.

The minority report helps us address situations where no data is found or an incorrect match occurs, preventing erroneous royalty calculations.

### Smart Contracts:

Smart contracts play a vital role in ensuring transparency and efficiency in royalty distribution.

They track and record the play count of each song, facilitating accurate revenue sharing among the artists and contributors.

Additionally, smart contracts provide an immutable record of transactions, which can be valuable for auditing and resolving any disputes related to royalty distributions.

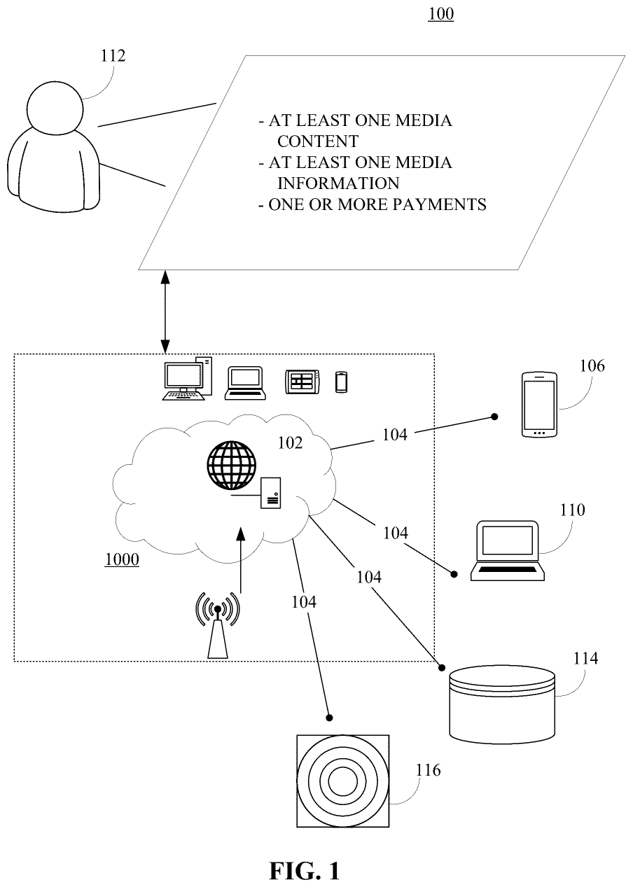

FIG. 1 is an illustration of an online platform 100 consistent with various embodiments of the present disclosure. By way of non-limiting example, the online platform 100 for music rights and royalties management with metadata tracking based on blockchain may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, service providers, musicians, artists, and administrators. Accordingly, in some instances, electronic devices operated by the one or more relevant parties may be in communication with the online platform 100.

A user 112, such as the one or more relevant parties, may access the online platform 100 through a web-based software application or browser. The web-based software application may be embodied as, for example, but not be limited to, a website, a web application, a desktop application, and a mobile application compatible with a computing device 1000.

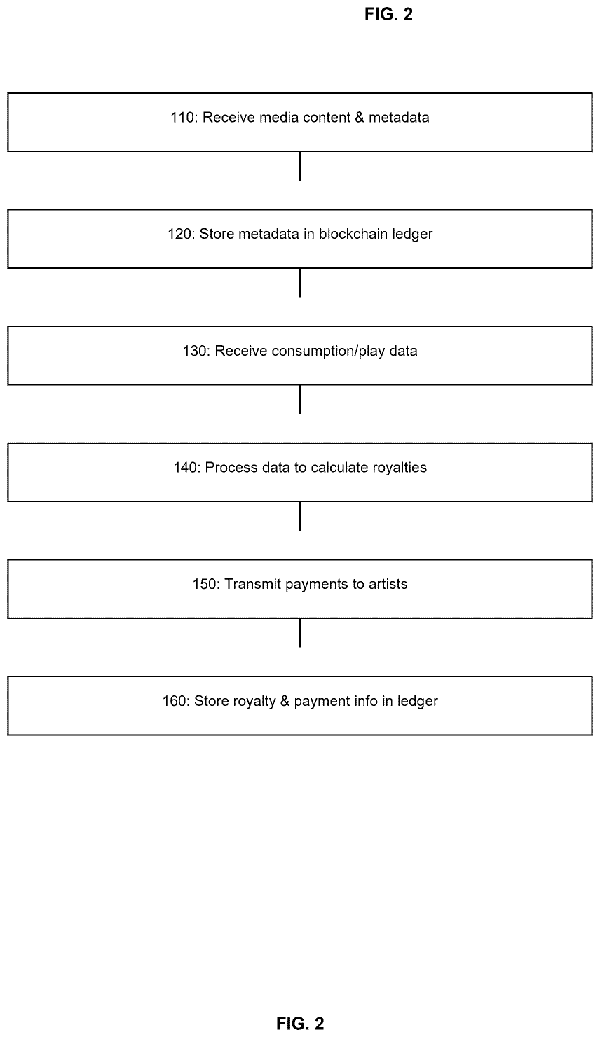

FIG. 2 is a flow diagram of a method for a smart contract for facilitating music rights and royalties management with metadata tracking based on blockchain, in accordance with some embodiments.

In further embodiments, a method for music rights and royalties management with metadata tracking based on blockchain is disclosed. Further, the method may include receiving, using a communication device, at least one media content and at least one media information associated with the at least one media content from at least one user device associated with at least one user. Further, the at least one media content may include an audio, an audio-video, etc. Further, in an instance, the at least one media content may include a song. Further, the at least one media information may include at least one contribution information, ownership information, album name, a media name, a release date, etc. Further, the at least one contribution information may include details associated with contribution of one or more artists in producing the at least one media content. Further, the at least one user may include an individual, an institution, and an organization that may want to perform music rights and royalties management with metadata tracking. Further, the at least one user device may include a smartphone, a tablet, a laptop, etc.

Further, the method may include storing, using a storage device, the at least one media information in a distributed ledger.

Further, the method may include receiving, using the communication device, a consumption data associated with the at least one media content from at least one second user device associated with at least one second user. Further, the at least one second user may include an individual, an institution, and an organization that may want to consume (hear or view) the at least one media content. Further, the at least one second user device may include a smartphone, a tablet, a laptop, etc.

Further, the method may include determining, using a processing device, a media consumption information based on the consumption data. Further, the consumption information may indicate a number of times a song is played, a portion of the song played, etc.

Further, the method may include processing, using the processing device, the media consumption information and the at least one contribution information.

Further, the method may include determining, using the processing device, a royalty distribution plan based on the processing. Further, the royalty distribution plan may include an amount of revenue received by each of the one or more artists.

Further, the method may include transmitting, using the communication device, one or more payments based on the royalty distribution plan to one or more artist devices associated with the one or more artists. Further, the one or payments may be associated with one or payment information. Further, the one or more artist devices may include a smartphone, a tablet, a laptop, etc.

Further, the method may include storing, using the storage device, the media consumption information, the royalty distribution information, and the one or more payment information in the distributed ledger.

In further embodiments, a system for music rights and royalties management with metadata tracking based on blockchain is disclosed. Further, the system may include a communication device configured for receiving at least one media content and at least one media information associated with the at least one media content from at least one user device associated with at least one user. Further, the at least one media content may include an audio, an audio-video, etc. Further, in an instance, the at least one media content may include a song. Further, the at least one media information may include at least one contribution information, ownership information, album name, a media name, a release date, etc. Further, the at least one contribution information may include details associated with contribution of one or more artists in producing the at least one media content. Further, the at least one user may include an individual, an institution, and an organization that may want to perform music rights and royalties management with metadata tracking. Further, the at least one user device may include a smartphone, a tablet, a laptop, etc.

Further, the communication device may be configured for receiving a consumption data associated with the at least one media content from at least one second user device associated with at least one second user. Further, the at least one second user may include an individual, an institution, and an organization that may want to consume (hear or view) the at least one media content. Further, the at least one second user device may include a smartphone, a tablet, a laptop, etc.

Further, the communication device may be configured for transmitting one or more payments based on the royalty distribution plan to one or more artist devices associated with the one or more artists. Further, the one or payments may be associated with one or payment information. Further, the one or more artist devices may include a smartphone, a tablet, a laptop, etc.

Further, the system may include a processing device configured for determining a media consumption information based on the consumption data. Further, the consumption information may indicate a number of times a song is played, a portion of the song played, etc. Further, the processing device may be configured for processing the media consumption information and the at least one contribution information. Further, the processing device may be configured for determining a royalty distribution plan based on the processing. Further, the royalty distribution plan may include an amount of revenue received by each of the one or more artists.

Further, the system may include a storage device configured for storing the at least one media information in a distributed ledger. Further, the storage device may be configured for storing the media consumption information, the royalty distribution information, and the one or more payment information in the distributed ledger.

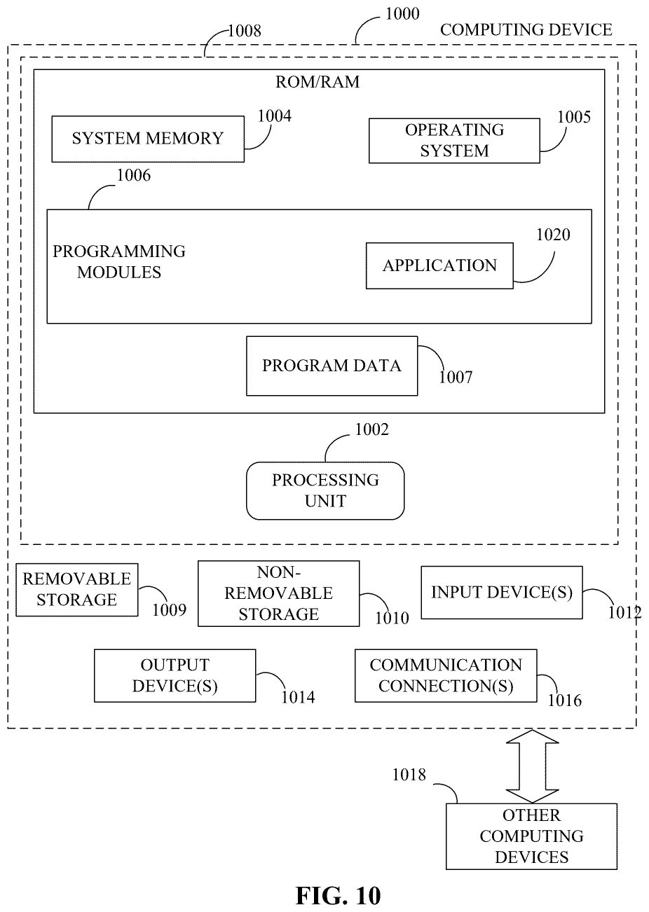

With reference to FIG. 10, a system consistent with an embodiment of the disclosure may include a computing device or cloud service, such as computing device 1000. In a basic configuration, computing device 1000 may include at least one processing unit 1002 and a system memory 1004. Depending on the configuration and type of computing device, system memory 1004 may comprise, but is not limited to, volatile (e.g. random-access memory (RAM)), non-volatile (e.g. read-only memory (ROM)), flash memory, or any combination. System memory 1004 may include operating system 1005, one or more programming modules 1006, and may include a program data 1007. Operating system 1005, for example, may be suitable for controlling computing device 1000's operation. In one embodiment, programming modules 1006 may include image-processing module, machine learning module and/or image classifying module. Furthermore, embodiments of the disclosure may be practiced in conjunction with a graphics library, other operating systems, or any other application program and is not limited to any particular application or system. This basic configuration is illustrated in FIG. 10 by those components within a dashed line 1008.

Computing device 1000 may have additional features or functionality. For example, computing device 1000 may also include additional data storage devices (removable and/or non-removable) such as, for example, magnetic disks, optical disks, or tape. Such additional storage is illustrated in FIG. 10 by a removable storage 1009 and a non-removable storage 1010. Computer storage media may include volatile and nonvolatile, removable and non-removable media implemented in any method or technology for storage of information, such as computer-readable instructions, data structures, program modules, or other data. System memory 1004, removable storage 1009, and non-removable storage 1010 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1000. Any such computer storage media may be part of device 1000. Computing device 1000 may also have input device(s) 1012 such as a keyboard, a mouse, a pen, a sound input device, a touch input device, a location sensor, a camera, a biometric sensor, etc. Output device(s) 1014 such as a display, speakers, a printer, etc. may also be included. The aforementioned devices are examples and others may be used.

Computing device 1000 may also contain a communication connection 1016 that may allow device 1000 to communicate with other computing devices 1018, such as over a network in a distributed computing environment, for example, an intranet or the Internet. Communication connection 1016 is one example of communication media. Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both storage media and communication media.

As stated above, a number of program modules and data files may be stored in system memory 1004, including operating system 1005. While executing on processing unit 1002, programming modules 1006 (e.g., application 1020 such as a media player) may perform processes including, for example, one or more stages of methods, algorithms, systems, applications, servers, databases as described above. The aforementioned process is an example, and processing unit 1002 may perform other processes. Other programming modules that may be used in accordance with embodiments of the present disclosure may include sound encoding/decoding applications, machine learning application, acoustic classifiers, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

1. A computer-implemented platform (“Raindrops on Petals Platform” or “ROP Platform”) comprising detailed methods, systems, and components for continuous monitoring, management, and distribution of music rights and royalties, implemented with blockchain or equivalent distributed ledger technologies and interoperable with cryptocurrency, digital wallets, and conventional electronic payment systems, the system comprising:
1.1. a user management component configured to enable differentiated registration and login for listeners, authors, and contributors, including authentication through email/password or wallet address;
1.2. an authoring component configured to enable authors to create albums, upload songs, and define revenue percentage splits among collaborators;
1.3; a contributor component comprising a dedicated dashboard for transparent royalty access and reporting;
1.4. a content management subsystem for data storage, retrieval, and indexing;
1.5. a blockchain integration component configured to store metadata and revenue distribution instructions within secure smart contracts, while allowing wallet or payment account integration;
1.6. a smart contract management system automating royalty distribution based on verified play counts, including optional speech recognition and metadata extraction functions;
1.7. a web application platform accessible by browser or equivalent digital interface;
1.8. music data management features including “Tracks & Plays” functionality to manage audio metadata, record plays, and interface with cloud hosting solutions for scalability;
1.9. a royalty distribution subsystem comprising:
(a) Golden Box Smart Contracts replicating rankings of most played songs and predicting hit potential using classification models;
(b) Majority Reports validating correct metadata matches and thereby triggering royalty disbursement;
(c) Minority Reports identifying data gaps or inconsistencies, preventing premature royalty payout and prompting audit.

2. The system of claim 1, wherein blockchain or distributed ledger integration facilitates secure, transparent, and immutable royalty distribution by:
(a) interoperating with cryptocurrency, digital wallets, and conventional payment accounts (including bank transfers and credit card processors);
(b) utilizing smart contracts to record and track play counts; and
(c) providing contributors with role-based dashboard access to contributions and royalty percentages.

3. The method of claim 1, wherein the request is transmitted to the Authoring Component platform that empowers authors by enabling them to create albums and upload songs using a user-friendly interface. Additionally, it allows authors to set revenue percentages for collaborators, fostering transparent and collaborative revenue sharing.

4. The method of claim 3, wherein the request includes reference data to a Contributor Component that provides contributors with a dedicated dashboard to access royalty-related data, granting real-time insights into their earnings.

5. The system of claim 3, wherein the reference data is a unique identifier to a Content Management System utilizing efficient data storage, offering scalability and flexibility compared to traditional relational databases.

6. The system of claim 1, wherein the Web Application Platform is developed as a user-friendly web application for accessibility, ensuring ease of use for all users by utilizing frontend and backend development.

7. The system of claim 1, wherein the request is transmitted to unique Music Data Management Features that include “Tracks & Plays” functionality, enabling comprehensive data management for music assets by managing music data and tracking plays. It leverages cloud storage and hosting solutions for scalability and performance, ensuring the system can handle large volumes of data and user traffic.

8. A method where blockchain technology facilitates seamless music management and royalty distribution through integrating with digital currency/cryptocurrency wallets for secure transactions, enhancing security and streamlining royalty payments compared to traditional financial methods: utilizing smart contracts to track play counts and record them on the blockchain, ensuring transparency and immutability of data; and providing contributors with access to view their contributions and associated royalty percentages through a dedicated dashboard, empowering contributors with real-time transparency into their earnings.

9. The method of claim 8, wherein the request is transmitted to a Blockchain Integration Component that stores metadata and revenue information within secure smart contracts, ensuring immutability and transparency of data, and enabling wallet integration for authors and contributors to connect their digital currency wallets for secure and efficient royalty payments.

10. The method of claim 8, wherein the request is transmitted to a Smart Contract Management System that automates royalty distribution based on play count, representing a significant improvement over manual royalty calculations. The system utilizes optional speech recognition for accurate song tracking, enhancing data accuracy, and offers the flexibility of optionally storing data in a local or online repository.

11. The method of claim 10, wherein the request includes Smart Contract Automation, automating royalty distribution for music based on play count data stored within the smart contracts, eliminating the need for manual calculations and ensuring transparent and efficient royalty distribution.

12. The method of claim 11, wherein the request is transmitted to a Royalty Distribution Platform comprising:
(a) Golden Box Smart Contracts replicating rankings of most played songs and identifying common features among them to provide valuable insights for artists and music labels; and
(b) Majority Reports generated when successful metadata matches are found, streamlining royalty distribution, and Minority Reports generated when no data or incorrect data is found, prompting further investigation to ensure data integrity and prevent fraudulent claims.

13. A unique system for exploring and predicting the future success of music through tracking, monitoring, and assessing the Golden Box Smart Contracts, Majority Reports, and Minority Reports.
